(19) United States
(12) Patent Application Publication
(10) Pub. No.: US 2009/0200529 A1
(43) Pub. Date: Aug. 13, 2009

(54) MULTI-USE HOIST SYSTEM

(75) Inventors: John Jerome Haigh, Fircrest, WA (US); John Thomas Albers, Fircrest, WA (US); Christopher Gavin Brickell, Renton, WA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: SafeWorks, LLC, Tukwila, WA (US)

(21) Appl. No.: 12/027,937

(22) Filed: Feb. 7, 2008

(51) Int. Cl. B66D 1/00

(52) U.S. Cl. 254/266; 254/385; 254/264

(57) ABSTRACT

Apparatus and methods repurpose a personnel hoist from a platform whereby at least one person can stand on said platform such that power applied to said hoist lifts the platform and at least one person. The personnel hoist is repurposed for use in material load applications by attaching it to a frame and attaching the frame to a support structure. As a result, applying power to the hoist then causes it to lift a material load. A wire rope from the personnel hoist is fed through a block to redirect the lift direction of the wire rope from the personnel hoist to lift the material load.

### FIELD OF THE INVENTION

This invention relates to use of hoists designed for lifting applications.

### BACKGROUND OF THE INVENTION

Hoists are used in a variety of applications such as construction, repair and maintenance of buildings and other structures, etc. There are two general varieties of hoists, personnel hoists and material hoists. A personnel hoist is designed to lift and lower equipment which supports one or more persons on a platform by means of a suspended path medium. A material hoist on the other hand is designed to lift and lower material by means of a suspended path medium. A suspended path medium is typically a wire rope, but may be made of other materials such as synthetic rope or chain. Wire rope is the most common type of suspended path media.

Personnel hoists are typically used to connect a platform or other suspended body to a fixture above. Personnel hoists, by means of a mechanical drive mechanism, lift or lower a platform between ground level and the fixture above. The platform is used to support a one or more persons. There are several types of personnel hoists that can be powered by electric, pneumatic, hydraulic, or other powered means. Personnel hoist may operate via traction sheave principle to tension or pull allowing travel along the wire rope. A personnel hoist may also operate by a drum wrap principle to tension and pull the wire rope.

Material hoists are used by attaching the material hoist to an overhead fixture and lowering a wire rope to a level below. The material hoist is used to lift a material load typically with a wire rope. The material hoists are powered similarly to the personnel hoists, e.g., by electric, pneumatic, hydraulic, or other powered means. The material hoists also use either a traction sheave or drum wrap principle to tension/pull the wire rope.

Personnel hoists have an attachment point for connecting the hoist to the platform and the wire rope is directed upward to connect to a fixture above. Safety codes generally require the personnel hoists to be mounted in this orientation in order to have safety mechanisms operate correctly. By contrast, material hoists have an attachment point for connecting the hoist to a fixture and the wire rope is directed downward to connect to a material load below.

There are numerous examples of hoist fixtures described in the prior art. For example, publication US2004/0124326 describes an adjustable frame work system to which a material hoist may be mounted. U.S. Pat. No. 5,082,248 describes a mechanism that is used to pull on or tension a line. U.S. Pat. No. 6,499,610 or US2005/0230340 described systems and methods for supporting a hoist or hoisting mechanisms.

### SUMMARY OF THE INVENTION

According to an aspect of the invention, apparatus and methods repurpose a hoist from a platform whereby at least one person can stand on said platform such that power applied to said hoist lifts the platform and at least one person. The hoist is repurposed by attaching it to a frame and attaching the frame to a support structure. As a result, applying power to the hoist then causes it to lift a material load. An aspect of the invention feeds a wire rope from a personnel hoist through a block to redirect the lift direction of the wire rope from the personnel hoist to lift a material load.

The apparatus comprises a frame having a support structure attachment point substantially at a top portion of the frame whereby the frame can be coupled to a support structure. The apparatus also has a bottom portion having a hoist attachment point. A personnel hoist having a wire outlet at a top portion of said hoist can be affixed to the frame. The block is attached to the top portion of the frame whereby a wire rope exiting from the top portion of the wire outlet is redirected in a downwardly traveling direction.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 illustrates the position and orientation of a typical personnel hoist.

FIG. 2 is an isometric illustration of the hoist drive mechanism for the personnel hoist.

FIG. 3 illustrates the position and orientation of a typical material hoist.

FIG. 4 illustrates an isometric view of the drive mechanism for the material hoist.

FIGS. 5 and 6 illustrate two isometric views of an apparatus used in repurposing of a personnel hoist in material handling applications.

FIGS. 7 and 8 illustrates isometric views of the apparatus of FIGS. 5 and 6 with the a typical personnel hoist mounted within.

FIG. 9 illustrates the repurposed personnel hoist as used in example material handling application.

FIG. 10 illustrates the doubling line feature of the repurposed personnel hoist.

FIG. 11 illustrates the apparatus in a fixed connection configuration.

FIG. 12 illustrates the apparatus in a rolling connection configuration.

### DETAILED DESCRIPTION OF ILLUSTRATIVE EMBODIMENTS

It is to be understood that the embodiments disclosed herein are not limited in application to the details of construction and the arrangement of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

The following description is based on an embodiment wherein a traction type hoist is being used. That is a wire rope enters the hoist, passes through a traction device providing the tensioning/pulling force, and then the wire rope exits the hoist. Alternatively, a drum type hoist may be used, where the wire rope would be wrapped and stored on a drum as part of the hoist body. In that embodiment, a trailing wire rope would not be seen and as the wire rope is wrapped onto a drum. The same orientations described in the case of the traction type hoist would hold true in the case of a drum type hoist.

According to an aspect of the invention a system, apparatus and method allow for the interchangeable use of a hoist for use in at least two applications, i.e. a material hoist and a personnel hoist. When used in conjunction with a personnel hoist, an aspect of the invention allows for the repurposing of the hoist for use in material hoisting applications. A frame, preferably comprising a metal, is used to fix a hoist in and attach to a supporting structure. The hoist is connected to the frame, preferably via a connection between a mounting point for the hoist and a hoist receiver mount in the frame. The hoist can then be mounted in an upright and design intended orientation. Preferably, the frame has a sheave block mounted to the underside of the upper plate of the frame. The hoist when mounted in the frame is preferably positioned and aligned between the hoist receiver mount and the sheave block. The sheave block is mounted to be inline with the wire rope exiting the top of the hoist. The wire rope travels out of the exit point in the top of the hoist and is directed through the sheave block. The sheave block directs the wire rope approximately 180 degrees to a direction downward below the hoist. The design shown uses a single sheave block, but a multiple sheave block design may be used for increased line wraps to increase lifting capacity. This design uses a slightly angled frame what allows the hoist to be pitched slightly forward towards the sheave block. This angled mounting allows for the use of a relatively small sheave while keeping the wire rope directed downward away from the frame and hoist to prevent any interference. Large sheaves may be used or varying angles of the hoisting mounting dependent on the specific design or desire to fit a given hoist design size and shape.

The frame has attachment points for securing the frame to a supporting structure. The frame also has a plate for the attachment of a travel limiting device as well as an attachment point allowing for the doubling of the line for increased lifting capacity. If a multiple sheave block is used the line could be tripled, quadrupled, etc. to increase the lifting capacity when used with a multiple sheave block at the material load. The frame also has an attachment point for the connection of a controlling or tag line when the frame is used in conjunction with a trolley or similar rolling support connection. The frame can be used with multiple hoist designs provided the hoist fits within the frame between the hoist receiver mount and installation and removal of the hoist using a minimum of common hand tools. The frame is also designed for the rapid connection and disconnection between the frame support attachment points and the supporting structure. The frame provides a low cost portable solution for the repurposing of personnel hoists to material hoisting applications.

A further feature is that the apparatus includes a wire rope guiding device which is composed of a flexible spring or other similar conduit that allows the trailing (non-load) end of the wire rope of hoist to be directed in a desirable direction.

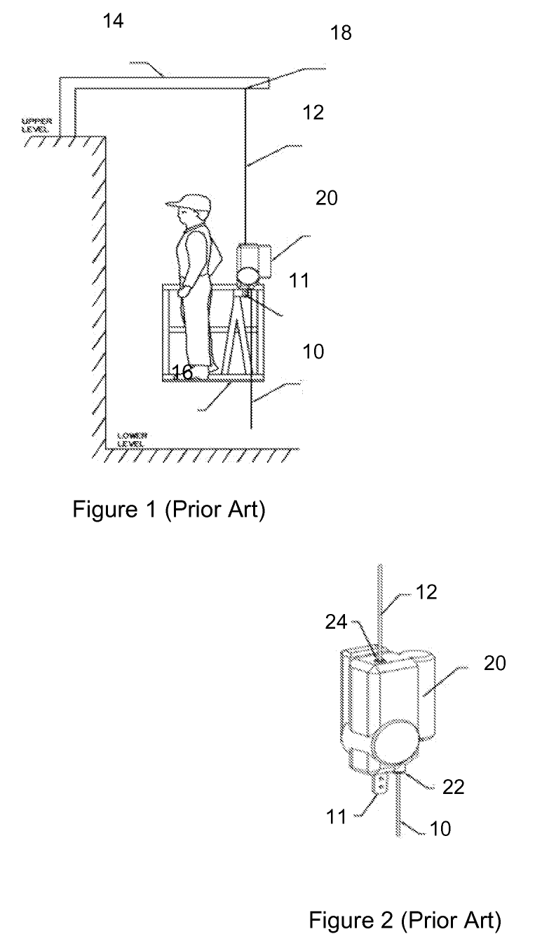

FIG. 1 shows the position and orientation of a typical personnel hoist 20. The personnel hoist 20 is attached to platform 16 on which personnel will be supported. The personnel hoist 20 is connected to platform 16 via hoist connection attachment point 11. The wire rope 12 up to the support structure 14 is directed upward to the wire rope connection to support structure 18. A portion 10 of the wire rope 12 exits the personnel hoist 20. This orients the personnel hoist 20 vertically with the wire rope 12 traveling a straight path between the support structure 14 and hoist connection attachment point 18.

FIG. 2 further illustrates the personnel hoist 20. As illustrated, personnel hoist 20 has attachment point 11. The wire rope enters the personnel hoist via wire rope inlet 24 and exits the personnel hoist at wire rope outlet 22.

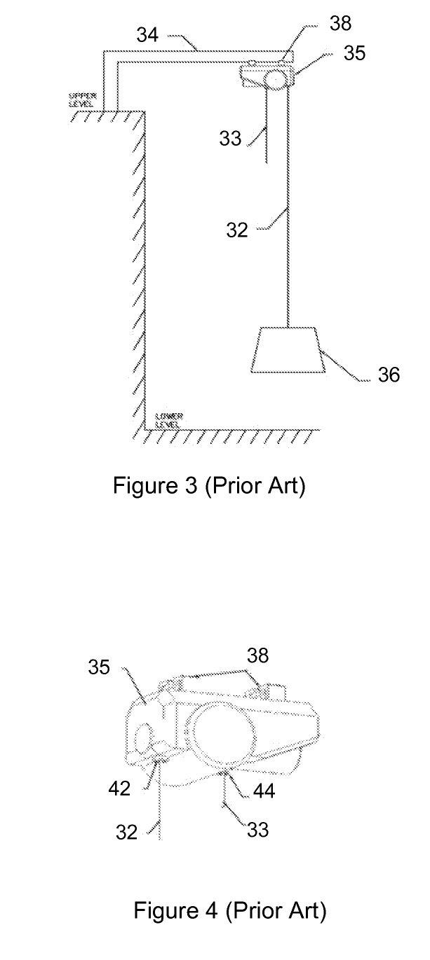

In contrast to the configuration of personnel hoist 20, FIG. 3 illustrates the position and orientation of a typical material hoist 35. Material hoist 35 is attached to a support structure 34 via hoist attachment connection point 38. The wire rope 32 is directed downward from material hoist 35 to material load 36 below. Excess wire rope 33 exits the material hoist as shown.

FIG. 4 further illustrates the details of material hoist 35. The wire rope inlet (13) and wire rope exit (14) are both below the hoist attachment connection point (9).

Note that the connection points and orientation of the personnel 20 and material hoists 35 are different. If personnel hoist 20 was used and mounted in the same manner as material hoist 35, personnel hoist attachment point 11 would be connected to a fixture and the wire rope would be directed downward. This would in effect orient personnel hoist 20 upside down from its designed position. Such a mounting orientation would prevent the safety mechanisms designed in personnel hoist 20 from operating. Given the previous description, material hoists 35 are designed to mount to an elevated fixture, e.g., 34 and lift material loads, e.g., 36 from below. There are various fixtures, structures, equipment to which material hoist 35 may be connected. The various supporting fixtures or structures to which a material hoist may be attached are well known to those of skill in the art. It is assumed that any material hoist must be attached to a supporting body at some height above the level at which the load to be lifted lies.

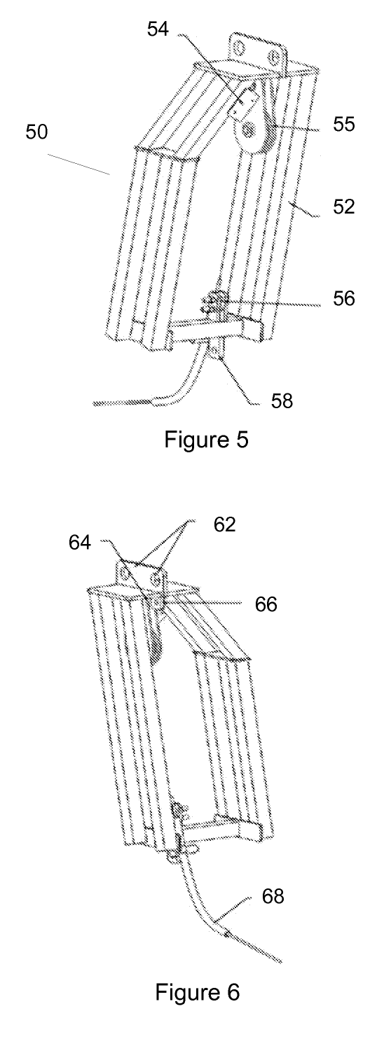

FIG. 5 illustrates an apparatus 50 for the configuring personnel hoist 20 in material handling applications. Apparatus 50 is composed of a sheave block 55 and a structural frame 52 composed of the following features; plate for travel limit device attachment 54, hoist receiver attachment point 56, doubling line attachment point 58.

FIG. 6 illustrates apparatus 50 from a different vantage point and illustrates sheave block attachment point 64, frame attachment point to structure 62, control/tag line attachment point 66, and a wire rope guide 68. The frame attachment point 62 is used to connect frame 52 to a supporting structure. A personnel hoist (not shown) can be connected to the hoist receiver attachment point 56. A wire rope runs out of the personnel hoist and through the sheave block 55. Wire rope guide 68 is used to direct the trailing wire rope exiting the personnel hoist down and away from the structural frame 52. Structural frame 52 may be made of any suitably rigid material such as a metal including steel, aluminum, an alloy, or a composite material.

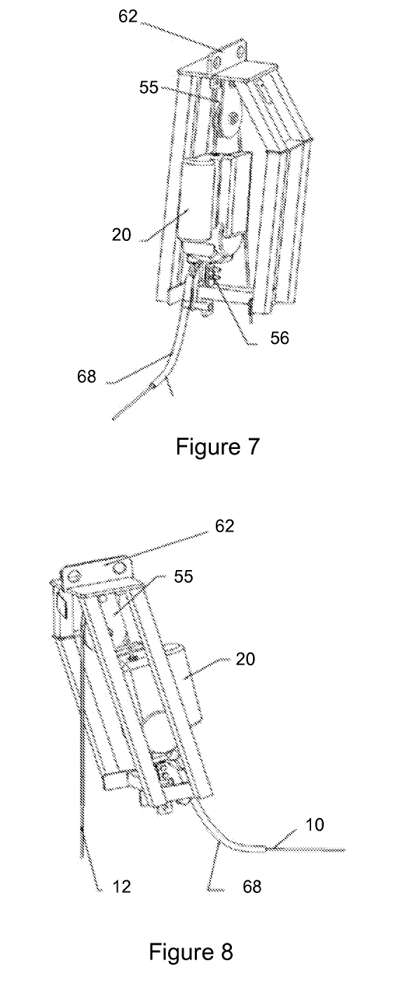

FIG. 7 illustrates personnel hoist 20 mounted in apparatus 50. Personnel hoist 20 is connected to frame 52 via hoist receiver attachment 56. The trailing wire rope is directed down and away from apparatus 50 by being directed through wire rope guide 68. The wire rope is directed down to reach the material load by passing through the sheave block 55. Apparatus 50 may in turn be attached to a support structure via the frame attachment point 62.

FIG. 8 illustrates a side view of the apparatus 50 having personnel hoist 20 mounted therein.

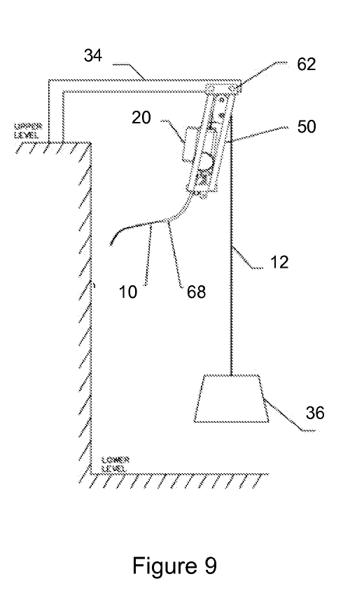

FIG. 9 illustrates personnel hoist 20 mounted in the apparatus 50 for use in hoisting material load 36. In the illustration, apparatus 50 is connected to a support structure 34 via frame attachment point 62. The wire rope is directed out of the hoist and through the sheave and then directed downward to attach to the material load 36 for lifting. The trailing wire rope is directed away from the apparatus via the wire rope guide 68.

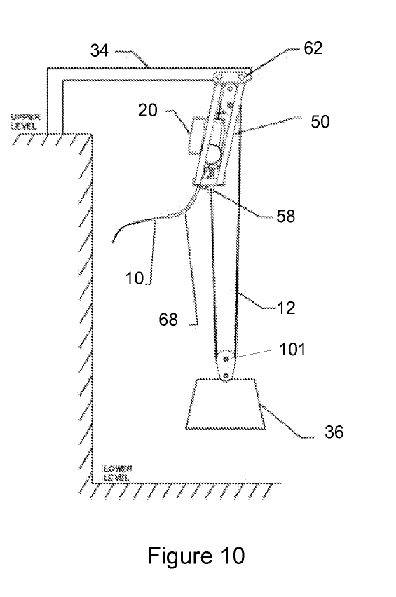

FIG. 10 shows the doubling line feature of apparatus 50. Here, wire rope 12 can be passed through an additional sheave block 101. Wire rope 12 is then connected up to the doubling line attachment point 58 on apparatus 50. This configuration effectively doubles the amount of load that can be lifted while using personnel hoist 20 at its rated capacity.

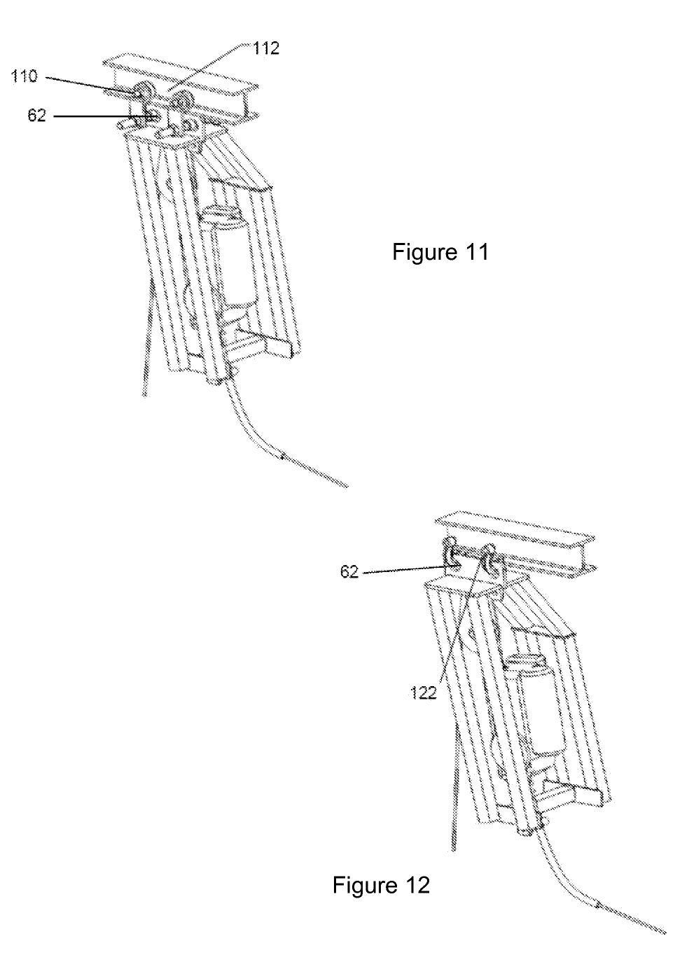

FIGS. 11 and 12 illustrate attachment of apparatus 50 to support structure 34. These two attachment configurations are illustrative and do not encompass nor describe all configurations that may be used to attach apparatus 50 to a given support structure.

FIG. 11 illustrates a trolley configuration (also called a rolling configuration). The trolley or rolling type of connection is used so that apparatus 50 may travel horizontally along a support structure. In that instance, the support structure would most commonly be an I-beam 112 or other rail type structure. In that instance wheels 110 are attached to attachment point 62, The wheels then ride on a ridge system of I-beam 112, for instance.

FIG. 12 illustrates a fixed point connection. A fixed point is used when apparatus 50 is fixed to the supporting structure and does not travel. In that configuration preferably clamp structures 122 attach apparatus 50 to the I-beam via attachment point 62.

It will be understood that each of the elements described above, or two or more together may also find a useful application in other types of methods differing from the type described above. Although the more detailed examples provided above relate to hoisting devices associated with elevated platforms for building maintenance and construction applications, it should be apparent to one of ordinary skill in the art that the apparatus and methods described herein will find application to other systems that utilize hoisting mechanisms. Additionally, the foregoing description has set forth various embodiments of the apparatus and methods via the use of diagrams and examples. While the present disclosure has been described in connection with the preferred embodiments of the various figures, it is to be understood that other similar embodiments may be used or modifications and additions may be made to the described embodiment for performing the same function of the present disclosure without deviating there from. Furthermore, it should be emphasized that a variety of applications, such as marine and transportation systems, are herein contemplated. Therefore, the present disclosure should not be limited to any single embodiment, but rather construed in breadth and scope in accordance with the appended claims. Additional features of this disclosure are set forth in the following claims.

What is claimed:

1. An hoist apparatus comprising:
a frame having an attachment point adapted for connection to a support structure;
at least one attachment point adapted to couple a personnel hoist having a wire rope;
a block coupled to the support structure and adapted to redirect the wire to lift a material load.

2. The hoist apparatus as recited in claim 1 wherein the frame comprises a wire rope attachment point that provides an attachment point for an end of said wire rope.

3. The hoist apparatus as recited in claim 1 wherein said frame comprises metal.

4. The hoist apparatus as recited in claim 1 comprising a trolley mechanism coupled to said frame whereby said hoist apparatus is movable on said support structure.

5. The hoist apparatus as recited in claim 1 wherein said attachment point adapted to couple said personnel hoist provides a substantially similar attachment structure to an attachment structure for a personnel platform.

6. The hoist apparatus as recited in claim 1 wherein said personnel hoist is mounted in a substantially upright position.

7. The hoist apparatus are recited in claim 1 wherein said frame comprises lateral support structures.

8. A method of using a hoist, comprising:
attaching a personnel hoist to a platform whereby at least one person can stand on said platform;
applying power to said personnel hoist to lift said platform and said at least one person;
attaching said personnel hoist to a frame;
attaching said frame to a support structure; and
applying power to said personnel hoist to lift a material load.

9. The method as recited in claim 8 comprising:
feeding a wire rope from said personnel hoist through a block to redirect the lift direction of said wire rope.

10. The method as recited in claim 8 comprising:
attaching an end of said wire rope to said frame such that the lift capacity is substantially increased.

11. An apparatus comprising:
a frame having a support structure attachment point substantially at a top portion of said frame whereby said frame can be coupled to a support structure and a bottom portion having a hoist attachment point;
a personnel hoist having a wire outlet at a top portion of said hoist;
a block attached to said top portion of said frame whereby a wire rope exiting from said top portion of said wire outlet is redirected in a downwardly traveling direction.

12. The apparatus as recited in claim 1 wherein said personnel hoist is mounted in a angular position within said frame.

13. The apparatus as recited in claim 1 wherein the hoist comprises a traction hoist.

14. The apparatus as recited in claim 1 wherein the hoist comprises a drum hoist.

15. The apparatus as recited in claim 1 wherein the wire rope comprises a synthetic material.

16. The apparatus as recited in claim 1 wherein the frame comprises a metal.

17. The apparatus as recited in claim 1 wherein the frame comprises wheels coupled to said support structure attachment point such that the frame is movably attached to said support structure.

18. The apparatus as recited in claim 1 comprising a wire rope attachment point fixed to said frame whereby said wire rope couples to said frame and increases the lift capacity of the apparatus.

19. The apparatus as recited in claim 1 comprising a wire rope guide whereby excess wire rope is guided away from said frame.

20. The method as recited in claim 19 wherein said wire rope guide comprises a conduit.
